(19) United States
(12) Patent Application Publication
(10) Pub. No.: US 2025/0002337 A1
(43) Pub. Date: Jan. 2, 2025

(54) SYSTEMS AND METHODS FOR HEAT UTILIZATION FROM GASIFICATION OF CARBONACEOUS FEEDSTOCKS

(71) Applicant: 8 Rivers Capital, LLC, Durham, NC (US)

(72) Inventor: Justin Kevin Miller, Durham, NC (US)

(21) Appl. No.: 18/745,324

(22) Filed: Jun. 17, 2024

Related U.S. Application Data
(60) Provisional application No. 63/523,473, filed on Jun. 27, 2023.

(51) Int. Cl. C01B 3/38

(52) U.S. Cl. CPC C01B 3/38; C01B 2203/0288; C01B 2203/0827; C01B 2203/0883; C01B 2203/169

(57) ABSTRACT

A system configured for and a method includes introducing a carbonaceous feedstock to a gasifier unit to produce a syngas stream. In addition, the system configured for and the method includes passing the syngas stream to a catalytic reactor unit that is configured to facilitate an exothermic catalytic reaction by use of the syngas stream to produce a heated syngas stream having a greater temperature than the syngas stream. Further, the system configured for and the method includes transferring heat into a carbon-dioxide-containing (CO₂-containing) stream of a power production unit utilizing of the heated syngas stream, where the power production unit is configured to circulate the CO₂-containing stream to produce electrical power.

### CROSS-REFERENCE TO RELATED APPLICATIONS

This application claims priority to and the benefit of U.S. provisional patent application No. 63/523,473 filed Jun. 27, 2023, and entitled “Systems and Methods for Heat Utilization From Gasification of Carbonaceous Feedstocks,” the entire contents of which are incorporated by reference.

### BACKGROUND

Gasification is a process for converting a carbonaceous feedstock into a mixture of gases, for example, nitrogen, hydrogen, carbon monoxide (CO), and carbon dioxide (CO₂), that is collectively referred to as “syngas” (synthesis gas). The carbonaceous feedstock may include coal, coke, biomass, or any other carbonaceous feedstock. Syngas, in turn, can be used as a fuel source, such as by combusting the flammable portions of the syngas in a furnace, engine, or reactor, or by utilizing the syngas as a hydrogen source for a hydrogen fuel cell.

### SUMMARY OF THE DISCLOSURE

One or more embodiments disclosed relate to a method including introducing a carbonaceous feedstock to a gasifier unit to produce a syngas stream. In addition, the method includes passing the syngas stream to a catalytic reactor unit that is configured to facilitate an exothermic catalytic reaction by use of the syngas stream to produce a heated syngas stream having a greater temperature than the syngas stream. Further, the method includes transferring heat into a carbon-dioxide-containing (CO₂-containing) stream of a power production unit utilizing of the heated syngas stream, where the power production unit is configured to circulate the CO₂-containing stream to produce electrical power.

One or more embodiments disclosed include a system including a gasifier unit configured to receive a carbonaceous feedstock and to produce a syngas stream. In addition, the system includes a catalytic reactor unit in fluid communication with the gasifier unit that is configured to facilitate an exothermic catalytic reaction by use of the syngas stream to increase a temperature and hydrogen content of the syngas stream and produce a heated syngas stream. Further, the system includes a power production unit that is configured to circulate a carbon-dioxide-containing (CO₂-containing) stream to produce electrical power, where the power production unit is in fluid communication with the catalytic reactor unit such that the CO₂-containing stream is heated by use of the heated syngas stream.

Embodiments described comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features previously described as well as others will be readily apparent to those having ordinary skill in the art upon reading the following detailed description, and by referring to the accompanying drawings. One should appreciate that this disclosure may be readily utilized as a basis for modifying or designing other structures for carrying out the same or similar purposes as the disclosed embodiments. One should also realize that such equivalent constructions do not depart from the spirit and scope of the principles disclosed.

### BRIEF DESCRIPTION OF THE DRAWINGS

For a detailed description of various embodiments, reference will now be made to the accompanying drawings in which:

FIG. 1 is schematic diagram of a system for carrying out a gasification process and harnessing heat energy from produced syngas, according to one or more embodiments;

FIG. 2 is a schematic diagram of a power production unit that may used in the system of FIG. 1, according to one or more embodiments; and

FIG. 3 is a schematic diagram of a CO₂ separation unit that may produce one or more purified CO₂ streams by use of one or more heated syngas stream output from the system of FIG. 1, according to one or more embodiments.

### DETAILED DESCRIPTION

As previously described, gasification is a process whereby carbonaceous fuel is converted into syngas. However, additional heat energy that may be derived from (or by use of) the produced syngas is often lost or wasted. Accordingly, the embodiments disclosed include systems and methods for performing a gasification reaction and recovering heat energy from the produced syngas for use in both the in the gasification process as well as in other processes and systems that may be upstream or downstream of the gasification reactor. For instance, one or more embodiments include systems that recover at least some heat energy from syngas for use in a power production unit that circulates a CO₂-containing stream to produce electrical power. Thus, through use of the embodiments disclosed, additional efficiency and utility may be derived from a gasification reaction.

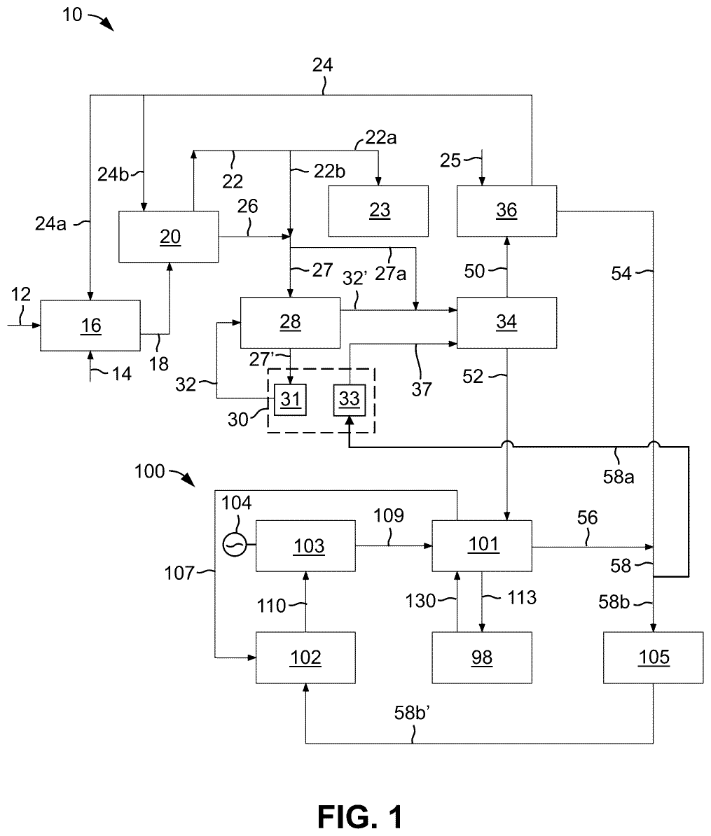

Referring now to FIG. 1, a system 10 for carrying out a gasification process and also harnessing usable energy from the produced syngas is shown according to some embodiments. System 10 includes a gasifier unit 16, which may comprise one or more reactors, subsystems, or other assemblies for producing a syngas stream 18 from a carbonaceous feedstock 14. An additional oxygen stream 12 and a first water stream 24a may be provided to the gasifier unit 16 to facilitate internal reaction(s). The first water stream 24a may comprise liquid water, steam, or some combination thereof.

The syngas stream 18 output from the gasifier unit 16 is routed to a heat exchange and cleaning assembly 20 that is configured to transfer heat from the syngas stream 18 to one or more other streams and to remove at least some undesirable constituents from the syngas stream 18. The heat exchange and cleaning assembly 20 may output a reduced-sulfur and cooled syngas stream 26, which may be more simply referred to as a “cooled syngas stream 26.” In one or more embodiments, the heat exchange and cleaning, assembly 20 may be configured to remove sulfur compounds from the syngas stream 18 via hydrolysis and adsorption or any other suitable process(es).

In addition, the heat exchange and cleaning assembly 20 may transfer heat from the syngas 18 to a second water stream 24b to thereby produce steam 22. As with the first water stream 24a, the second water stream 24b may comprise liquid water, steam, or some combination thereof. In one or more embodiments, the heat exchange and cleaning assembly 20 may be configured to convert liquid water in the second water stream 24b into steam or to at least to increase a steam content of the second water stream 24b.

A first portion 22a of the steam 22 may be provided to another process 23. The other process 23 may comprise another chemical process that is performing one or more chemical reactions by use of the steam 22a or heat therefrom. The other process 23 may also or alternatively comprise an electrical power generation process that utilizes a steam turbine. A second portion 22b of the steam 22 may be combined with the cooled syngas stream 26 to produce a mixed feed stream 27 for an exothermic catalytic reactor unit 30, which may be referred to more simply as a “catalytic reactor unit 30.” The mixed feed stream 27 may initially be flowed to a heat exchanger 28 that is configured to heat the mixed feed stream to output a preheated mixed feed stream 27′ prior to introduction thereof into the exothermic catalytic reactor unit 30. In one or more embodiments, a portion 27a of the mixed feed stream 27 may be bypassed round the heat exchanger 28 and exothermic catalytic reactor unit 30.

The catalytic reactor unit 30 may be configured to perform, promote, or facilitate any suitable exothermic chemical reaction(s) that may both increase a temperature of the syngas as well as increase a hydrogen content of the syngas. In one or more embodiments, the catalytic reactor unit 30 may be configured to carry out a water-gas shift reaction using a suitable catalyst where at least some of the CO and water (H₂O) in the preheated mixed feed stream 27′ is converted into CO₂ and molecular hydrogen (H₂). However, other potential reaction(s) are contemplated for the catalytic reactor unit 30.

In one or more embodiments, the catalytic reactor unit 30 may comprise a plurality of water-gas shift reactors, such as a first water-gas shift reactor 31 and a second water-gas shift reactor 33. The reactors 31, 33 may be configured to facilitate water-gas shift reactions at different temperatures. Specifically, first water-gas shift reactor 31 may generally operate at greater temperatures than the second water-gas shift reactor 33, such that the first water-gas shift reactor 31 may be referred to as a “high-temperature” shift (HTS) reactor 31 and the second water-gas shift reactor 33 may be referred to as a “low-temperature” shift (LTS) reactor 33.

In one or more embodiments, the HTS reactor 31 may be configured to operate at an inlet temperature of about 300° C. to about 350° C., inclusive, and at an outlet temperature of about 450° C. to about 550° C., inclusive. Conversely, the LTS reactor 33 may be configured to operate at an inlet temperature of about 175° C. to about 220° C., inclusive, and at an outlet temperature of about 250° C. to about 300° C., inclusive. However, different numbers of water-gas shift reactors, such as three or more reactors or a single reactor, are contemplated in one or more embodiments. In one or more embodiments, a plurality of reactors of the catalytic reactor unit 30 may be utilized, and each reactor may receive a portion of the feed and be operated at a different condition to produce a heated syngas stream at a different temperature, composition, or both, based on the thermal needs of the system 10 or other coupled systems or processes as described.

The preheated mixed stream 27′ may be routed from the heat exchanger 28 to the HTS reactor 31 of the catalytic reactor unit 30, which in turn outputs a hot and hydrogen-enriched syngas stream 32. The hot syngas stream 32 is then routed through the heat exchanger 28 to pre-heat the mixed feed stream 27 and produce the preheated mixed stream 27′ as previously described. Thus, both the syngas 18 and second portion 22b of steam 22 are utilized as reactants to produce the hot syngas stream 32.

After heating the preheated mixed feed stream 27′, the heated syngas stream 32′ is routed to a heat transfer control assembly 34. In one or more embodiments, the heat transfer control assembly 34 may include manifold(s), valving, or other suitable assemblies that are configured to selectively distribute heated syngas to one or more destinations. As described in more detail, the heated syngas distributed from the heat transfer control assembly 34 may comprise the heated syngas streams that are output from the catalytic reactor unit 30, including the HTS reactor 31, the LTS reactor 33, or combinations thereof.

As shown in FIG. 1, one or more embodiments, which may be combined with other embodiments, the heat transfer control assembly 34 may be configured to output a first heated syngas stream 50 to a heat exchanger assembly 36 to heat one or more streams associated with one or more of the gasifier unit 16, heat exchange and cleaning assembly 20, and the catalytic reactor unit 30.

The heat exchanger assembly 36 may output a first cooled syngas stream 54 that is derived from the first heated syngas stream 50. Specifically, in the embodiment shown in FIG. 1, the heat exchanger assembly 36 may include one or more heat exchangers that are configured to transfer heat from the first heated syngas stream 50 to an incoming water stream 25 to produce a heated water stream 24. The heated water stream 24 may be split into the first water stream 24a, which is routed to the gasifier unit 16, and the second water stream 24b, which is routed to the heat exchange and cleaning assembly 20 as previously described. The heated water stream 24 may comprise liquid water, steam, such as wet or dry steam, or some combination thereof. In one or more embodiments, the heat exchanger assembly 36 may include one or more heat exchangers that are configured to heat the oxygen stream 12 that is provided to the gasifier 16 by use of the first heated syngas stream 50. Although not shown in FIG. 1, In one or more embodiments, the heat exchanger assembly 36 may be configured to directly output the first heated water stream 24a and the second heated water stream 24b as separate streams that are not combined as the heated water stream 24. In such instances, the streams 24a, 24b may be different in at least some characteristic, such as in composition, temperature, or pressure.

In addition, as shown in FIG. 1, heat exchanger assembly 36 may include one or more heat exchangers that are configured to heat one or more other streams associated with the heat exchange and cleaning assembly 20, other than the heated water stream 24. In one or more embodiments, the heat exchanger assembly 36 may transfer heat to the gasifier 16 or the heat exchange and cleaning assembly 20 (or another assembly, unit, or stream) via another fluid or medium in addition to or alternatively to streams 24a, 24b. For instance, in one or more embodiments, the heat exchanger assembly 36 may transfer heat from the first heated syngas stream 50 to the gasifier 16, heat exchange and cleaning assembly 20, or one or more streams associated therewith (including steam or water streams) via a suitable heat transfer fluid such as fluids offered under the name THERMINOL® by the Eastman Chemical Company or other suitable fluids, materials, or mediums.

In one or more embodiments, which may be combined with other embodiments, the heat transfer control assembly 34 may be configured to output a second heated syngas stream 52 to another downstream process or unit. Thus, the downstream process or unit may be in fluid communication with the catalytic reactor unit 30 via the heat transfer control assembly 34 and second heated syngas stream 52. In some embodiments, the heat transfer control assembly 34 may be configured to output a select one of the heated syngas streams 50, 52, or a combination of the heated syngas streams 50, 52 as shown in FIG. 1. In one or more embodiments, the downstream process may include an electrical power production unit 100, which may more simply be referred to as a “power production unit 100.”

The power production unit 100 may comprise a supercritical CO₂ (sCO₂) power production unit, such as a power production cycle known as the Allam-Fetvedt Cycle. Specifically, in one or more embodiments, the power production unit 100 can incorporate elements, operating parameters, or both, as described in U.S. Pat. No. 9,068,743 to Palmer et al., U.S. Pat. No. 9,062,608 to Allam et al., U.S. Pat. No. 8,986,002 to Palmer et al., U.S. Pat. No. 8,959,887 to Allam et al., U.S. Pat. No. 8,869,889 to Palmer et al., U.S. Pat. No. 8,776,532 to Allam et al., and U.S. Pat. No. 8,596,075 to Allam et al, the disclosures of which are incorporated by reference.

In one or more embodiments, the power production unit 100 can be configured such that a working fluid comprising CO₂ is cycled at least through stages of compressing, heating, expanding, and cooling. The CO₂ can be supercritical (sCO₂) through at least one or more of these steps, although the CO₂ may transition between fluid states of supercriticality, gaseous, and liquid in one or more embodiments, which may be combined with other embodiments. In one or more embodiments, which may be combined with other embodiments, a suitable power production process may include one or more of the following steps:
combustion of a fuel, for example, a heated syngas stream, with an oxidant in the presence of a recycled CO₂ stream to provide a combustion product stream (such as stream 110 shown in FIG. 1) at a temperature of at least about 500° C., such as at least about 700° C., for example, in a range of from about 500° C. to about 2000° C., such as in a range of from about 600° C. to about 1500° C., and a pressure of at least about 100 bar (10 Megapascals (MPa)), such as at least about 200 bar (20 Mpa), for example, in a range of from about 100 bar (10 Mpa) to about 500 bar (50 Mpa), and such as in a range of from about 150 bar (15 Mpa) to about 400 bar (40 Mpa);
expansion of combustion product stream, for example, a pressure of at least about 100 bar (10 MPa), such as at least about 200 bar (20 Mpa), for example, in a range of from about 100 bar (10 Mpa) to about 500 bar (50 Mpa), and such as in a range of from about 150 bar (15 Mpa) to about 400 bar (40 Mpa), across a turbine for power production, forming an expanded exhaust stream that includes CO₂;
cooling of the expanded exhaust stream, for example, at a temperature, as previously noted, particularly of a turbine discharge stream, in a recuperative heat exchanger, forming an expanded, cooled, recycled CO₂ stream;
condensing water from and separating out of the expanded, cooled, recycled CO₂ stream in an ambient cooler, the remainder of the combustion products being present in a dried combustion product stream that has been expanded and cooled;
compressing the dried recycled CO₂ stream to an increased pressure, for example, to a pressure as previously noted, optionally being carried out in multiple stages with inter-cooling heat exchangers between the stages to increase stream density, forming a compressed recycled CO₂;
heating the compressed recycled CO₂ stream in the recuperative heat exchanger, particularly heating against a cooling turbine exhaust stream, forming a heated, compressed recycled CO₂; and
optionally transferring additional heat to the heated, compressed recycled CO₂ stream from a secondary source, such as the second heated syngas stream 52 as described.

FIG. 1 shows one potential embodiment of the power production unit 100 for receiving heat, fluid, or both, for example, via second syngas stream 52 during operations. Although the embodiments power production unit 100 are described below in relation to some specific operating parameters, one of ordinary skill in the art understands that the power production unit 100 can be operated across a range of parameters consistent with the overall disclosure. For example, any temperature, pressure, concentration, or other operative parameter(s) included in the embodiments of power production unit 100 are understood as being suitable for varying in one or more embodiments by, for example, +/− 30%, +/− 20%, +/− 10%, or +/− 5% comparatively of the value of the operative parameter.

In some embodiments, the power production unit 100 receives the second heated syngas stream 52 from the heat transfer control assembly 34. Specifically, the second heated syngas stream 52 may be routed through a heat exchanger 101 of the power production unit 100 to thereby transfer heat from the second heated syngas stream 52 to one or more other streams of the power production unit 100 as described. In addition, as will be described in more detail, the second heated syngas stream 52 may receive heat within the heat exchanger 101 to cool an exhaust stream 109 output from a turbine 103 of the power production unit 100 within the heat exchanger 101.

The heat exchanger 101 may output a second cooled syngas stream 56. The second cooled syngas stream 56 may be combined with the first cooled syngas stream 54 that was output from the heat exchanger assembly 36 as previously described, to form a combined cooled syngas stream 58. A first portion 58a of the combined syngas stream 58 may be routed back to the LTS reactor 33 of the catalytic reactor unit 30 to facilitate additional water-gas shift reactions and recover additional heat. The LTS reactor 33 may produce an additional heated syngas stream 37 that is routed to the heat transfer control assembly 34. The heat transfer control assembly 34 may then distribute the additional heated syngas stream 37 as or into one or both heated syngas streams 50, 52 as previously described. While not specifically shown in FIG. 1, it should be appreciated that in one or more embodiments, the LTS reactor 33 may receive the first cooled syngas stream 54 or the second cooled syngas stream 56, in addition to or in lieu of the first portion 58a of the combined cooled syngas stream 58.

The heat transfer control assembly 34 may utilize one or more or combinations of the heated syngas stream 32 and additional heated syngas stream 37 to produce the first and second heated syngas streams 50, 52. In addition, the heat transfer control assembly 34 may also mix additional streams, such as the bypass stream 27a, into the first heated syngas stream 50 or second heated syngas stream 52. For instance, in one or more embodiments, the bypass stream 27a may be used by the heat transfer control assembly 34 to reduce a temperature of the first heated syngas stream 50 or the second heated syngas stream 52 so as to achieve a desired temperature or temperature profile for the streams 50 or 52 during operations.

A second portion 58b of the combined heated syngas stream 58 may be compressed via a compressor 105 to produce a compressed combined heated syngas stream 58b′ that is then routed to a combustor 102 of the power production unit 100. The combustor 102 also receives a hot recycled CO₂ stream 107, which may comprise sCO₂ as previously described). Within the combustor 102, at least a portion of the compressed combined heated syngas stream 58b′ is combusted using an oxidant, such as air or oxygen in the presence of the recycled CO₂ stream 107, to produce a combustion product stream 110 that includes the recycled CO₂ stream 107 and the products of combustion of the compressed combined heated syngas stream 58b′.

The combustion product stream 110 is routed to a turbine 103, where it is expanded to actuate a generator 104 to generate electrical power. The output from turbine 103 as a turbine exhaust stream 109 (or more simply “exhaust stream 109”). The exhaust stream 109 then flows to the heat exchanger 101 where it is cooled by the CO₂ stream 130 and second syngas stream 52 as previously described. The cooled exhaust stream 109 is then output as a cooled, expanded stream 113 to a water removal assembly 98.

The water removal assembly 98 may comprise additional vessels, reactors, exchanger that further cool and dry, for example, by condensing and removing water, cooled, expanded stream 113 to produce a CO₂-containing stream 130, which may comprise a sCO₂ stream. The CO₂-containing stream 130 may comprise a majority portion of CO₂, such as at least about 50 molar percent (“mol %”) CO₂, such as at least about 75 mol % CO₂, such as at least about 90 mol % CO₂, or such as at least about 95 mol % CO₂. In one or more embodiments, the CO₂-containing stream 130 and thus the recycled CO₂ stream 107 comprise less than 3 mol %, such as less than 2 mol %, such as less than 1 mol %, such as less than 0.5 mol %, such as less than 0.1 mol %, or such as less than 0.01 mol % impurities, that is, constituents that are not CO₂.

The CO₂-containing stream 130 is then heated in the heat exchanger 101 by at least the exhaust stream 109 and the second heated syngas stream 52, and then recycled to the combustor 102 as the recycled CO₂ stream 107. Thus, without being limited to this or any other theory, the heated syngas streams 32 and 37 produced via system 10 may be used to further heat one or more streams of the power production unit 100. Specifically, heat from the second heated syngas stream 52 may be used to cool the exhaust stream 109 and/or the heat the CO₂ stream 130 within the heat exchanger 101. In addition (or alternatively), at least a portion of the second heated syngas stream 52 may be combusted in the combustor 102 to heat the CO₂ stream 107.

In one or more embodiments, the power production unit 100 may be configured to operate to provide a shortage of heat to the CO₂ stream via the heat exchanger 101 in the absence of the heat provided from the second heated syngas stream 52. For instance, in one or more embodiments, the shortage of heat to the CO₂ stream 130 may be in a range from about 50° C. to about 250° C. Thus, the additional heat provided by the second heated syngas stream 52 via the heat transfer control assembly 34 may be configured to provide the additional heat necessary to eliminate or at least substantially reduce this heat shortage for the hot CO₂ stream 107 during operations.

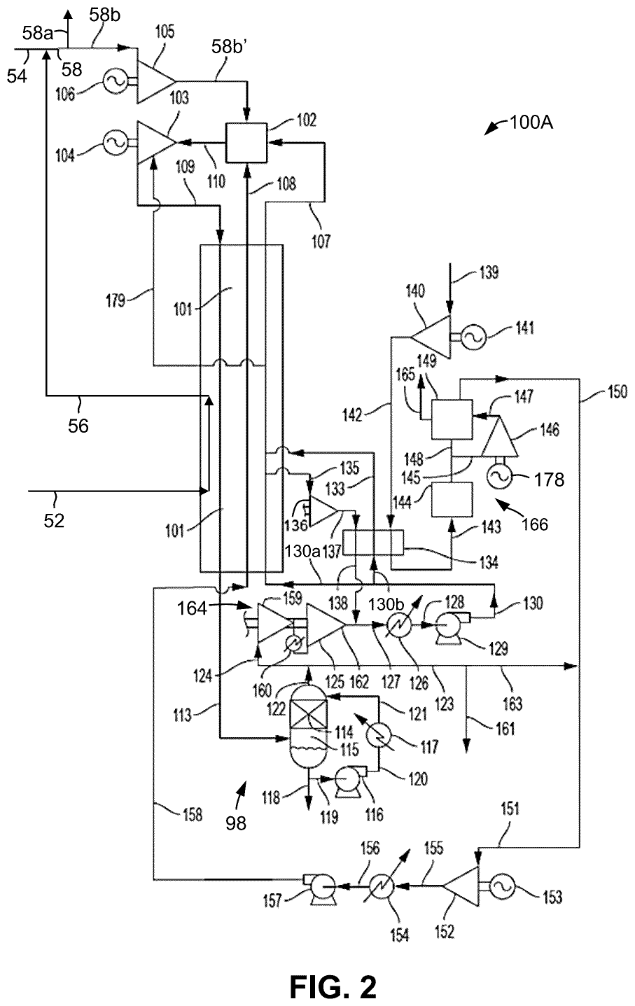

Referring now to FIG. 2, another example embodiment of a power production unit 100A for receiving heat or fluid, for example, via the second heated syngas stream 52, from the system 10 (FIG. 1) is shown. Thus, the power production unit 100A may be used in place of the power production unit 100 shown in FIG. 1 and previously described. The power production unit 100A may be similar to and include one or more of the same components of the power production unit 100. As a result, the same reference numbers are utilized in FIG. 2 to identify components of the power production unit 100A that are shared with the power production unit 100 shown in FIG. 1.

In the example of power production unit 100A shown in FIG. 2, the CO₂ stream 107 enters combustor 102 where it mixes with the combustion products derived from the combustion of the compressed combined heated syngas stream 58b′ and an oxidant stream 108. In one or more embodiments, the CO₂ stream 107 may be at a pressure of about 304 bar and may be heated to about 715° C. in the heat exchanger 101 prior to entering the combustor 102. In one or more embodiments, the compressed combined heated syngas stream 58b′ may be compressed via the compressor 105 so that it has a pressure of about 305 bar and a temperature of about 251° C. In one or more embodiments, the compressor 105 may be driven by an electric motor 106. In one or more embodiments, the oxidant stream 108 may comprise a composition of about 25 mol % oxygen to about 75 mol % CO₂, and may be heated to about 715° C. in the heat exchanger 101.

The resulting combustion product stream 110 enters the turbine 103 and is expanded to thereby generate electrical power via generator 104 and output the exhaust stream 109 as previously described. In one or more embodiments, the combustion product stream 110 may enter the turbine 103 at a temperature of about 1150° C. and a pressure of about 300 bar, and the exhaust stream 109 may exit the turbine 103 at a temperature of about 725° C. and a pressure of about 30 bar.

The exhaust stream 109 cools in the heat exchanger 101 so as to transfer heat to the CO₂ stream 107. The cooled exhaust stream 109 may then exit the heat exchanger as the cooled, expanded stream 113. In one or more embodiments, the cooled, expanded stream 113 may be at a temperature of about 65° C.

The cooled, expanded stream 113 is then further cooled in the compressor and water removal assembly 98 as previously described. In one or more embodiments, the power production compressor and water removal assembly 98 includes a direct contact water cooler 115 that receives the cooled, expanded stream 113. The direct contact water cooler 115 may have a packed section 114 and a circulating water section. The circulating water section comprises a pump 116 and an indirect water-cooled heat exchanger 117. During operations, the circulating water section directs water flows 119, 120 and 121 to the top of the packing section 114 of water cooler 115 to cool the incoming cooled, expanded stream 113. Excess liquid water is removed from the base of water cooler 115 as a stream 118.

A cooled stream of substantially pure CO₂ 122 exits the top of the cooler 115 and splits into multiple streams. Specifically, a first portion 123 of the substantially pure CO₂ stream 122 is divided into a net CO₂ product stream 161 and a diluent stream 163. The net CO₂ product stream 161 may be drawn off for export or other use. The diluent stream 163 may blend with a combustor oxygen flow 150 to form the combustor oxidant stream 151 as described in more detail.

A second portion 124 of the cooled, substantially pure CO₂ 122 enters a two-stage intercooled CO₂ compressor 164 of the compressor and water removal assembly 98. The two-stage intercooled CO₂ compressor 164 includes a first compressor stage 159, an intercooler 160, and a second compressor stage 125. The second portion 124 of the cooled, substantially pure CO₂ stream 122 may be compressed in this two-stage intercooled CO₂ compressor 164 to produce a stream 162. In one or more embodiments, the stream 162 may be compressed to about 67.5 bar via the two-stage intercooled CO₂ compressor 164. In one or more embodiments, the substantially pure CO₂ stream 122 exiting the cooler 115 (and thus also the portions 123, 124 of stream 122) is substantially pure in that it comprises less than 3 mol %, such as less than 2 mol %, such as less than 1 mol %, such as less than 0.5 mol %, such as less than 0.1 mol %, or such as less than 0.01 mol % impurities.

The power production unit 100A can benefit by addition of a quantity of otherwise generated heat to the high-pressure CO₂ stream 107. For instance, in one or more embodiments, additional heat is at least partially derived from the second heated syngas stream 52 via heat exchanger 101 as previously described. Additional sources of heat may also be utilized in other embodiments. For instance, an additional source of heat is an adiabatically compressed cryogenic oxygen plant feed air stream 142 output from an air compressor 140. In one or more embodiments, the air compressor 140 may be driven by an electric motor 141 to compress an air stream 139 adiabatically to produce the compressed air stream 142 at a pressure of about 5.6 bar and a temperature of about 226° C.

Another potential source of heat for the CO₂ stream 107 is a CO₂ stream 135 that is split from the CO₂ stream 107 in the heat exchanger 101. The CO₂ stream 135 may be adiabatically compressed in a compressor 136 to produce a compressed stream 137. In one or more embodiments, the CO₂ stream 135 may be at a temperature of about 135° C. and about 29.3 bar, and the compressed stream 137 may be at a temperature of about 226° C.

The streams 137, 142 may be passed through additive heat exchanger 134 where they provide additive heat to a CO₂ stream 130b that is split from the CO₂ stream 130 that is taken directly from a multi-stage pump 129. The additive heat from the additive heat exchanger 134 raises the temperature of the CO₂ from 50° C. in stream 130b to 221° C. in stream 133.

The compressed stream 137 may exit the additive heat exchanger 134 as a cooled CO₂ stream 138. The cooled CO₂ stream 138 is then combined with the CO₂ recycle compressor discharge stream 162 to form the total CO₂ stream 127. The total CO₂ stream 127 is then cooled in a cooling water heat exchanger 126 to produce a CO₂ recycle stream 128. In one or more embodiments, the CO₂ recycle stream 128 may be at a temperature of about 19.7° C.

The CO₂ recycle stream 128 may then be compressed in the multi-stage pump 129 to produce the CO₂ stream 130 as previously described. In one or more embodiments, the CO₂ stream 130 may be at a pressure of about 305 bar and a temperature of about 50° C. The CO₂ stream 130 may then be divided into a first portion 130a which enters the recuperative heat exchanger 101 and a second portion 130b that is heated in heat exchanger 134 against the cooling adiabatically compressed streams 137 and 142 to produce the stream 133 as previously described. In one or more embodiments, the stream 133 may be heated to about 221° C. via the additive heat exchanger 134, and then may rejoin the first portion 130a in heat exchanger 101. In this manner, additive heating is provided to the CO₂ stream 130 to achieve a greater level of operating efficiency. A side stream 179 can be taken from the first portion 130a and directed to the turbine 103 as a turbine blade cooling stream.

The compressed air stream 142 may be emitted from the additive heat exchanger 134 as a cooled air stream 143. In one or more embodiments, the cooled air stream 143 may be at a temperature of about 56° C. The cooled air stream 143 then enters a cryogenic air separation system 166, which comprises an air purification unit 144. The air purification unit 144 includes a direct contact air cooler, a water chiller, and a switching dual bed thermally regenerated adsorption unit that delivers a dry CO₂-free air stream. In one or more embodiments, the dry CO₂-free air stream may be at a pressure of about 5.6 bar and a temperature of about 1220 C. A first portion 145 of this dry CO₂-free air stream, is compressed in a compressor 146 that is driven by electric motor 178 to produce a compressed stream 147. In one or more embodiments, the compressed stream 147 may be compressed to a pressure of about 70 bar in the compressor 146.

A second portion 148 of the dry CO₂-free air stream, and the compressed stream 147 may enter a pumped liquid oxygen cycle air separation cryogenic system 149 of the cryogenic air separation system 166. The products from the air separation cryogenic system 149 are a waste nitrogen stream 165 and a product oxygen stream 150, which blends with the diluent stream 163 leaving the direct contact CO₂ cooler 115 to produce the oxidant stream 151 as previously described. In one or more embodiments, the product oxygen stream 150 may be at a pressure of about 30 bar.

The oxidant stream 151 is compressed in compressor 152 driven by electric motor 153 leaving as a stream 155, which is cooled in intercooler 154, leaving as stream 156, which is compressed further in pump 157. The resulting compressed oxidant stream 158 is heated in heat exchanger 101 leaving as stream 108 to enter the combustor 102 as previously described. In one or more embodiments, the compressed oxidant stream 158 may be at a pressure of about 304 bar.

The power production unit 100A of FIG. 2 can specifically utilize a cryogenic air separator plant to produce oxygen; however, it is understood that oxygen may be provided by any suitable source or method. In some embodiments, oxygen may be delivered to the combustor 102 at a controlled concentration and then diluted with CO₂ to desired molar ratio. In some embodiments, the oxidant stream 108 provided to the combustor may have an oxygen content in a range of from about 20 mol % to about 30 mol % and may be preheated to a temperature of at least 700° C. in the heat exchanger 101.

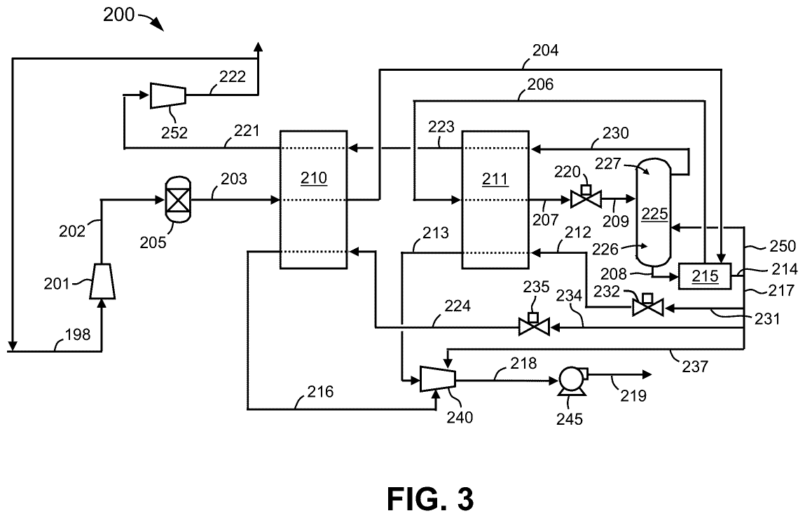

As previously described, in some embodiments, the heat transfer control assembly 34 (FIG. 1) may route heated syngas stream or heat therefrom to a CO₂ separation unit. As with FIGS. 1 and 2, the same numbers from those figures are utilized in FIG. 3 to represent the same streams and units. For instance, as illustrated in FIG. 3, an embodiment of the CO₂ separation unit 200 that may receive at least a portion of a heated syngas stream 198 from the heat transfer control assembly 34 is shown. The heated syngas stream 198 may comprise a portion of the first heated syngas stream 50, a portion of the second heated syngas stream 52, or another heated syngas stream that is output form the heat transfer control assembly 34 shown in FIG. 1.

The heated syngas stream 198 may contain at least some CO₂. As illustrated in FIG. 3, the syngas stream 198 can initially be compressed within a compressor 201. In one or more embodiments, the compressor 201 may compress the syngas stream 198 to a pressure of at least about 30 bar, at least about 35 bar, or at least about 40 bar, such as to a maximum of about 100 bar. In one or more embodiments, the compressor 201 may be an intercooled multi-stage compressor. In one or more embodiments, the compression step via the compressor 201 may raise the partial pressure of the CO₂ within the syngas stream 198 to at least about 15 bar up to a maximum of about 55 bar. For instance, in one or more embodiments, the CO₂ partial pressure can be raised via the compressor 201 to be in the range of from about 15 bar to about 55 bar, such as from about 15 bar to about 45 bar, or such as from about 15 bar to about 40 bar.

The compressed syngas stream 202 is then directed to a drier 205 to reduce the moisture content of the compressed process stream and to form a first impure CO₂ stream 203. The extent of moisture removal can be adjusted as desired. For instance, in one or more embodiments, the dew point of the first impure CO₂ stream 203 may be reduced to a temperature of about −60° C. In one or more embodiments, the dew point of the first impure CO₂ stream 203 can be reduced to a temperature of about −10° C. or less, such as about −20° C. or less, or such as about −40° C. or less, or such as to a temperature of about −60° C. For example, the dew point of the first impure CO₂ stream 203 can be reduced to a temperature in the range of from about −60° C. to about −10° C., such as from about −60° C. to about −20° C., or such as from about −60° C. to about −30° C. In one or more embodiments, the drier 205 can be a drying bed packed with appropriate desiccant material, such as molecular sieves or zeolites.

The first impure CO₂ stream 203 is cooled to significantly reduce the temperature thereof and ultimately form a two-phase stream that is then subject to rapid cooling utilizing auto-refrigeration. In one or more embodiments, auto-refrigeration can generally refer to refrigeration that is carried out in the express absence of any external refrigerant. In other words, the two-phase stream may not be cooled against a refrigerant stream containing a traditional refrigerant composition, such as refrigerants offered under the name FREON® by the Chemours Company FC, LLC, or other refrigerants such as liquid nitrogen, liquid propane, ammonia, or the like. Rather, the two-phase stream may be cooled against further streams produced in the CO₂ separation process and using expansion techniques. In particular, auto-refrigeration can refer to a process whereby at least one stream comprising a liquid component is expanded to provide for rapid cooling of the two-phase stream.

Returning to FIG. 3, the first impure CO₂ stream 203 is directed to a first heat exchanger 210 to partially cool and form a second impure CO₂ stream 204. Thereafter, the second impure CO₂ stream 204 is directed to a reboiler heat exchanger 215 to further cool down and form a third impure CO₂ stream 206. The third impure CO₂ stream 206 is further cooled down in a second heat exchanger 211 to form a fourth impure CO₂ stream 207. The foregoing cooling steps can be effective to provide the impure CO₂ stream(s) 203, 204, 206, 207 in a two-phase form including a gaseous component and a liquid component.

To further facilitate cooling of the impure CO₂ stream, the fourth impure CO₂ stream 207 is expanded within a first valve 220 to produce an expanded impure CO₂ stream 209. In one or more embodiments, the first valve 220 may be configured to expand the fourth impure CO₂ stream 207 such that the expanded impure CO₂ stream 209 has a temperature that is near the CO₂ triple point temperature. For instance, in one or more embodiments, the first valve 220 may be configured to drop the temperature of the fourth impure CO₂ stream 207 to about −56.4° C. For example, in one or more embodiments, expansion of the fourth impure CO₂ stream 207 can be effective to reduce the difference in temperature of the fourth impure CO₂ stream 207 to be within about 15° C. differential, such as within about 10° C. differential, or such as within about 5° C. differential, of the freezing point of the CO₂ in the fourth impure CO₂ stream 207. Thus, a cold, two-phase CO₂ stream 209 exits the first valve 220.

The cold two-phase CO₂ stream 209 may then become a feed stream to a mass transfer column 225. The mass transfer column 225 has a stripping section 226 below the feed point of stream 209 that is configured to produce a high purity liquid CO₂ stream 208 as a bottom product. In addition, the mass transfer column 225 has a rectifying section 227 above the feed point of stream 209 that is configured to produce a purified top vapor phase product stream 230. The mass transfer column 225 is packed with appropriate packing material that is configured to enhance mass transfer and the collection of the high-purity, liquid CO₂. The design of the mass transfer column 225 may be such that it can effectively handle a two-phase feed stream. For instance, the feed to the mass transfer column 225 may be flashed in a suitable flash vessel prior to the entering to the mass transfer column 225. In addition, or alternatively, the mass transfer column 225 may include a gallery tray, chimney tray, or any combination thereof.

In one or more embodiments, the high-purity liquid CO₂ stream 208 may contain about 80 mol %, such as at least about 85 mol %, of the total CO₂ within the expanded impure CO₂ stream 209. A remainder of the CO₂ content and other volatile impurities in the expanded impure CO₂ stream 209 may exit the mass transfer column 225 as the purified top vapor phase product stream 230. In one or more embodiments, the high-purity liquid CO₂ stream 208 may contain at least about 50 mol %, such as at least about 60 mol %, such as at least about 70 mol %, or such as at about least 80 mol %, of the total CO₂ within the fourth impure CO₂ stream 207. For instance, the high-purity liquid CO₂ stream 208 may contain in a range of from about 50 mol % to about 99 mol %, such as from about 60 mol % to about 98 mol %, such as from about 70 mol % to about 95 mol %, or such as from about 75 mol % to about 90 mol %, of the total CO₂ within the fourth impure CO₂ stream 207. The high-purity liquid CO₂ stream 208 passes through the reboiler heat exchanger 215 to be heated and exits as purified a CO₂ product stream 214 that splits into a first portion 217 and a second portion 250. The first portion 250 may be recycled back into the bottom section of the mass transfer column 225.

The purified top vapor phase product stream 230 can be used as a source of refrigeration to cool down the impure CO₂ streams 203, 206 in heat exchangers 210, 211, respectively. In one or more embodiments, the heat exchangers 210, 211 may comprise plate and fin heat exchangers that may comprise aluminum or any other suitable material. In one or more embodiments, the heat exchangers 210, 211 may be designed and fabricated as a single unit with two (or more) sub-unit or sections. In one or more embodiments, the high-purity liquid CO₂ stream 208 is at least 80 mol % pure CO₂, such as at least 85 mol % pure CO₂, such as at least 90 mol % pure CO₂, such as at least 95 mol % pure CO₂, such as at least 98 mol % pure CO₂, such as at least 99 mol % pure CO₂, such as at least 99.5 mol % pure CO₂, or such as at least 99 mol % pure CO₂.

To generate additional refrigeration duty, the first portion 217 of the CO₂ product stream 214 can be divided into three (3) separate streams 231, 234, and 237. The streams 231 and 234 can be reduced in pressure by expansion in valves 232 and 235, respectively, to achieve appropriate temperature profiles in heat exchangers 211 and 210. Specifically, purified CO₂ product stream 231 exits valve 232 as a stream 212 and passes through heat exchanger 211 to result in a purified CO₂ stream 213. Similarly, purified CO₂ product stream 234 exits valve 235 as a stream 224 and passes through heat exchanger 210 to result in a purified CO₂ stream 216. Although each of streams 212 and 224 are illustrated as passing through respective ones of heat exchangers 210 and 211, it is understood that one or both of streams 212 and 224 may be passed through both of heat exchangers 210 and 211 prior to passing to the compression step to be described. The purified CO₂ streams 213, 216, 237 are partially pressurized and mixed within a compressor 240 to form a high-density CO₂ stream 218 before being raised in pressure to the desired end-use pressure in a liquid pump 245 to leave as a final CO₂ product stream 219.

The top vapor phase product stream 230 may be warmed in heat exchanger 211 to form a stream 223 and then heated in heat exchanger 210 to form a stream 221 at near ambient temperature. The stream 221 can be compressed in compressor 252 to form a stream 222. As shown in FIG. 3, the stream 222 can be at least partially combined with the syngas feed stream 198, and this recycle allows for a favorable increase in the overall CO₂ recovery from the syngas feed stream 198. Furthermore, the stream 222 can be partially or completely recycled back as the feedstock to a chemical production process, such as the system 10, the power production units 100, 100A.

As explained previously and reiterated here, the present disclosure includes, without limitation, the following embodiments and example implementations.

Clause 1: A method, comprising: (a) introducing a carbonaceous feedstock to a gasifier unit to produce a syngas stream; (b) passing the syngas stream to a catalytic reactor unit that is configured to facilitate an exothermic catalytic reaction by use of the syngas stream to produce a heated syngas stream having a greater temperature than the syngas stream; and (c) transferring heat into a carbon-dioxide-containing (CO₂-containing) stream of a power production unit utilizing of the heated syngas stream, where the power production unit is configured to circulate the CO₂-containing stream to produce electrical power.

Clause 2: The method of any of the clauses, where (c) comprises: (c1) transferring heat into the CO₂-containing stream using the heated syngas stream by use of a heat exchanger such that a cooled syngas stream and a recycled CO₂ stream are produced.

Clause 3: The method of any of the clauses, where (c) further comprises: (c2) combusting the cooled syngas stream in a combustor of the power production unit in the presence of the recycled CO₂ stream to produce a combustion product stream, the combustion product stream comprising the recycled CO₂ stream and one or more combustion products resulting from the combustion of the cooled syngas stream.

Clause 4: The method of any of the clauses, further comprising: (d) expanding the combustion product stream through a turbine to produce electrical power.

Clause 5: The method of any of the clauses, where the catalytic reactor unit comprises a first water-gas shift reactor and a second water-gas shift reactor, where the first water-gas shift reactor is configured to produce syngas at a greater temperature than the second water-gas shift reactor, and where (b) comprises passing the syngas stream to the first water-gas shift reactor.

Clause 6: The method of any of the clauses, further comprising: (e) passing at least a portion of the cooled syngas stream to the second water-gas shift reactor as a recycle stream to produce an additional heated syngas stream; and (f) passing at least a portion of the additional heated syngas stream to the heat exchanger to heat the CO₂-containing stream of the power production unit.

Clause 7: The method of any of the clauses, further comprising: (g) transferring heat from the heated syngas stream to the gasifier unit.

Clause 8: The method of any of the clauses, where (g) comprises: (g1) heating a water stream by use of the heated syngas stream; and (g2) passing the water stream to the gasifier unit.

Clause 9: The method of any of the clauses, further comprising: (h) passing a first portion of the water stream to a heat exchange and cleaning assembly, where the heat exchange and cleaning assembly is configured to reduce a sulfur content of the syngas stream at least partially by use of the first portion of the water stream.

Clause 10: The method of any of the clauses, further comprising: (i) producing steam by use of the first portion of the heated syngas stream; and (j) passing at least a portion of the steam to the catalytic reactor unit along with the syngas stream.

Clause 11: The method of any of the clauses, further comprising: (k) separating a CO₂ enriched stream from at least a portion of the heated syngas stream by use of a CO₂ separation unit.

Clause 12: A system, comprising: a gasifier unit configured to receive a carbonaceous feedstock and to produce a syngas stream; a catalytic reactor unit in fluid communication with the gasifier unit that is configured to facilitate an exothermic catalytic reaction by use of the syngas stream to increase a temperature and hydrogen content of the syngas stream and thereby produce a heated syngas stream; and a power production unit that is configured to circulate a carbon-dioxide-containing (CO₂-containing) stream to produce electrical power, where the power production unit is in fluid communication with the catalytic reactor unit such that the CO₂-containing stream is heated by use of the heated syngas stream.

Clause 13: The system of any of the clauses, where the power production unit comprises a heat exchanger that is configured to transfer heat from the heated syngas stream to the CO₂-containing stream and output a cooled syngas stream derived from the heated syngas stream and a recycled CO₂ stream derived from the CO₂-containing stream.

Clause 14: The system of any of the clauses, where the power production unit further comprises a combustor that is configured to combust the cooled syngas stream in the presence of the recycled CO₂ stream to produce a combustion product stream.

Clause 15: The system of any of the clauses, where the power production unit further comprises a turbine that is configured to expand the combustion product stream to actuate a generator to produce electrical power and to produce an expanded stream that is routed to the heat exchanger.

Clause 16: The system of any of the clauses, where the catalytic reactor unit comprises a first water-gas shift reactor and a second water-gas shift reactor, where the first water-gas shift reactor is configured to receive the syngas stream and output the heated syngas stream, and where the second water-gas shift reactor is configured to receive at least a portion of the cooled syngas stream and output an additional heated syngas stream, the additional heated syngas stream having a temperature that is less than a temperature of the heated syngas stream.

Clause 17: The system of any of the clauses, where the power production unit is in fluid communication with the catalytic reactor unit such that the CO₂-containing stream is heated by use of the heated syngas stream and the additional heated syngas stream.

Clause 18: The system of any of the clauses, further comprising a heat exchanger assembly that is in fluid communication with the catalytic reactor unit and the gasifier unit such that the heat exchanger assembly is configured to: transfer heat from the heated syngas stream to a water stream to produce a heated water stream; and pass at least a first portion of the heated water stream to the gasifier unit.

Clause 19: The system of any of the clauses, further comprising a heat exchange and cleaning assembly that is configured to reduce a sulfur content of the syngas stream by use of at least a second portion of the heated water stream.

Clause 20: The system of any of the clauses, further comprising a CO₂ separation unit that is in fluid communication with the catalytic reactor unit such that the CO₂ separation unit configured to separate a CO₂ enriched stream from at least a portion of the heated syngas stream.

The embodiments disclosed include systems and methods for performing a gasification reaction that recover available energy, (for example, via heat, from the produced syngas for use both the in the gasification process itself as well as in various other processes and systems that may be upstream or downstream of the gasifier unit. For instance, as previously described, the energy of the produced syngas may be transferred to a power production unit or a CO₂ purification unit. Thus, through use of the embodiments disclosed, a gasification unit may be utilized to improve the overall efficiency of the associated plant or production facility.

The preceding discussion is directed to various exemplary embodiments. However, one of ordinary skill in the art will understand that the examples disclosed have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components may be shown exaggerated in scale or in somewhat schematic form and some details of conventional elements may not be shown in interest of clarity and conciseness.

In the discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used, the terms “axial” and “axially” generally mean along or parallel to a given axis (for example, central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used (including in the claims), the words “about,” “generally,” “substantially,” “approximately,” and the like, when used in reference to a stated value mean within a range of plus or minus 10% of the stated value.

While exemplary embodiments have been shown and described, modifications thereof can be made by one skilled in the art without departing from the scope or teachings. The embodiments described are exemplary only and are not limiting. Many variations and modifications of the systems, apparatus, and processes described are possible and are within the scope of the disclosure. Accordingly, the scope of protection is not limited to the embodiments described, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method, comprising:
(a) introducing a carbonaceous feedstock to a gasifier unit to produce a syngas stream;
(b) passing the syngas stream to a catalytic reactor unit that is configured to facilitate an exothermic catalytic reaction by use of the syngas stream to produce a heated syngas stream having a greater temperature than the syngas stream; and
(c) transferring heat into a carbon-dioxide-containing (CO₂-containing) stream of a power production unit utilizing of the heated syngas stream, where the power production unit is configured to circulate the CO₂-containing stream to produce electrical power.

2. The method of claim 1, where (c) comprises:
(c1) transferring heat into the CO₂-containing stream using the heated syngas stream by use of a heat exchanger such that a cooled syngas stream and a recycled CO₂ stream are produced.

3. The method of claim 2, where (c) further comprises:
(c2) combusting the cooled syngas stream in a combustor of the power production unit in the presence of the recycled CO₂ stream to produce a combustion product stream, the combustion product stream comprising the recycled CO₂ stream and one or more combustion products resulting from the combustion of the cooled syngas stream.

4. The method of claim 3, further comprising:
(d) expanding the combustion product stream through a turbine to produce electrical power.

5. The method of claim 3, where the catalytic reactor unit comprises a first water-gas shift reactor and a second water-gas shift reactor, where the first water-gas shift reactor is configured to produce syngas at a greater temperature than the second water-gas shift reactor, and where (b) comprises passing the syngas stream to the first water-gas shift reactor.

6. The method of claim 5, further comprising:
(e) passing at least a portion of the cooled syngas stream to the second water-gas shift reactor as a recycle stream to produce an additional heated syngas stream; and
(f) passing at least a portion of the additional heated syngas stream to the heat exchanger to heat the CO₂-containing stream of the power production unit.

7. The method of claim 1, further comprising:
(g) transferring heat from the heated syngas stream to the gasifier unit.

8. The method of claim 7, where (g) comprises:
(g1) heating a water stream by use of the heated syngas stream; and
(g2) passing the water stream to the gasifier unit.

9. The method of claim 8, further comprising:
(h) passing a first portion of the water stream to a heat exchange and cleaning assembly, where the heat exchange and cleaning assembly is configured to reduce a sulfur content of the syngas stream at least partially by use of the first portion of the water stream.

10. The method of claim 9, further comprising:
(i) producing steam by use of the first portion of the heated syngas stream; and
(j) passing at least a portion of the steam to the catalytic reactor unit along with the syngas stream.

11. The method of claim 1, further comprising:
(k) separating a CO₂ enriched stream from at least a portion of the heated syngas stream by use of a CO₂ separation unit.

12. A system, comprising:
a gasifier unit configured to receive a carbonaceous feedstock and to produce a syngas stream;
a catalytic reactor unit in fluid communication with the gasifier unit that is configured to facilitate an exothermic catalytic reaction by use of the syngas stream to increase a temperature and hydrogen content of the syngas stream and thereby produce a heated syngas stream; and
a power production unit that is configured to circulate a carbon-dioxide-containing (CO₂-containing) stream to produce electrical power, where the power production unit is in fluid communication with the catalytic reactor unit such that the CO₂-containing stream is heated by use of the heated syngas stream.

13. The system of claim 12, where the power production unit comprises a heat exchanger that is configured to transfer heat from the heated syngas stream to the CO₂-containing stream and output a cooled syngas stream derived from the heated syngas stream and a recycled CO₂ stream derived from the CO₂-containing stream.

14. The system of claim 13, where the power production unit further comprises a combustor that is configured to combust the cooled syngas stream in the presence of the recycled CO₂ stream to produce a combustion product stream.

15. The system of claim 14, where the power production unit further comprises a turbine that is configured to expand the combustion product stream to actuate a generator to produce electrical power and to produce an expanded stream that is routed to the heat exchanger.

16. The system of claim 13, where the catalytic reactor unit comprises a first water-gas shift reactor and a second water-gas shift reactor, where the first water-gas shift reactor is configured to receive the syngas stream and output the heated syngas stream, and where the second water-gas shift reactor is configured to receive at least a portion of the cooled syngas stream and output an additional heated syngas stream, the additional heated syngas stream having a temperature that is less than a temperature of the heated syngas stream.

17. The system of claim 16, where the power production unit is in fluid communication with the catalytic reactor unit such that the CO₂-containing stream is heated by use of the heated syngas stream and the additional heated syngas stream.

18. The system of claim 12, further comprising a heat exchanger assembly that is in fluid communication with the catalytic reactor unit and the gasifier unit such that the heat exchanger assembly is configured to:
transfer heat from the heated syngas stream to a water stream to produce a heated water stream; and
pass at least a first portion of the heated water stream to the gasifier unit.

19. The system of claim 18, further comprising a heat exchange and cleaning assembly that is configured to reduce a sulfur content of the syngas stream by use of at least a second portion of the heated water stream.

20. The system of claim 12, further comprising a CO₂ separation unit that is in fluid communication with the catalytic reactor unit such that the CO₂ separation unit configured to separate a CO₂ enriched stream from at least a portion of the heated syngas stream.
